(19) United States
(12) Patent Application Publication
(10) Pub. No.: US 2024/0342955 A1
(43) Pub. Date: Oct. 17, 2024

(54) METHOD AND APPARATUS FOR DELIVERY AND FEEDING OF MATERIAL AND ELECTRICITY FOR CONSTRUCTION 3D PRINTING

(71) Applicant: Apis Cor Inc., Melbourne, FL (US)

(72) Inventors: Nikita Cheniuntai, Melbourne, FL (US); Anna Cheniuntai, Melbourne, FL (US)

(21) Appl. No.: 18/587,152

(22) Filed: Feb. 26, 2024

Related U.S. Application Data
(63) Continuation of application No. 17/475,857, filed on Sep. 15, 2021, now abandoned.
(60) Provisional application No. 63/078,997, filed on Sep. 16, 2020.

(51) Int. Cl. B28C 7/04; B28B 1/00; B28C 7/00; B33Y 40/00; B33Y 50/02

(52) U.S. Cl. CPC B28C 7/0418; B28B 1/001; B28C 7/0084; B33Y 40/00; B33Y 50/02

(57) ABSTRACT

Systems described herein relate to a mobile material transport system for 3D printing construction. Embodiments of the mobile material transport system include a portable container configured to store a granular material, such as a dry mix mortar. The system also includes a feed system coupled to the portable container that may continuously expel the granular material through a material output valve at a steady feed rate that may be controlled to adjust the feed rate up or down. Additionally, the system may include a power supply that powers the feed system, as well as any additional construction equipment, such as a material mixer or 3D printer.

### RELATED APPLICATION

This application claims the benefit of U.S. Provisional Application No. 63/078,997, filed on Sep. 16, 2020. The entire teachings of the above application are incorporated herein by reference.

### FIELD OF THE INVENTION

The methods and apparatus described herein relate to equipment for the supply of material and electricity for 3-D printing construction.

### BACKGROUND

Currently, there remain several fundamental and significant limitations within the construction industry leading to current construction methods being slow, expensive, complex, labor intensive, and hazardous. One major limitation of prior art concrete structures and construction methods is the common use of iron rebar, which suffers from corrosion, availability, and the constant price fluctuations dependent on “supply and demand.” These iron-reinforced concrete structures generally require maintenance, and significant repair after about 50 to 100 years, due to iron oxidization, which significantly limits the lifespan of the structures. In the United States alone, the estimated cost to repair these and other associated problems in concrete structures is approaching $300 billion annually. Furthermore, employing conventional construction technology, even a modest-sized structure usually requires the time and efforts of numerous specialized trades and individuals, presenting the added challenge of organizing those specialized individuals to cooperate in an efficient manner.

Despite the availability of modern construction machinery such as cranes, pumps, concrete mixers, and form works, the construction industry currently depends primarily on manual labor of professional contractors that operate the machinery and tools. Thus, current concrete construction is very costly and time consuming. These skilled laborers construct structures using expensive methods and materials, such as reinforced concrete and masonry forms, that are generally rectilinear, significantly restricting architectural designs. Costs increase significantly when constructing complex concave/convex surfaces, for example, that conventionally require the pre-construction of expensive formworks and iron reinforcement cages, further including their transport, assembly, and then casting. Additionally, virtually all conventional construction systems require skilled workers to constantly refer to site plans (blueprints), and this practice can be slow and expensive, often producing inconsistent results. The appearance and quality of one structure can vary from another built from the same site plans and materials.

Within the prior art, using manual labor for construction is often very time-consuming, often requiring several months and, in some instances years, to complete. This can be due to differences in the laborers' skills, tolerances, sites, supervision, and techniques employed by those that work on the structures. Another important consideration is that conventional concrete construction systems typically result in significant amounts of wasted materials and time. For example, when concrete forms are used, they are commonly purchased in standardized off-the-shelf sizes, and often must be cut to meet site design requirements, resulting in waste of material, labor, and time. Further, the materials require purchasing, inventorying, storage, and transportation, including their cleaning and discarding, or storage for subsequent re-use.

3D printing is a manufacturing process, commonly called “additive manufacturing,” that typically involves building objects in successive layers based on 3D models. With respect to the construction industry, large-scale 3D printers have been used to produce structural buildings from construction materials such as a dry mix mortar or a concrete. Some examples of construction 3-D printers have been described in U.S. Pat. Nos. 10,780,637 and 10,486,330. In many of these large-scale 3D printers, the construction material is extruded through a nozzle to build structural components layer by layer.

Material used in connection with 3D printing construction is typically a dry mix mortar like plaster. In traditional construction, plaster is used for plastering work that takes a long time (about a month, depending on the project). Therefore, in traditional construction, this type of material is stored in silos at the construction site. FIG. 1 shows a portable silo system 100 used in the prior art. Silos 120 are delivered separately and by a special machine 110 and left on site as part of on-site preparation for construction. A separate dry bulk truck brings the plaster from the factory and unloads it into the silo, and leaves the site.

### SUMMARY

In the case of 3D printing houses, buildings or other large structures, the 3D printing process may require a dry mix mortar material for building, similar to that is used in traditional construction materials. However, unlike traditional construction where plastering work can take a long time, the consumption of the material for 3D printing construction can occur quickly over the course of several days. Therefore, the delivery and installation of a dry material silo, and subsequent delivery of the material to the silo can add additional time and complexity to the process. The systems and methods described herein relate to eliminating the need for a separate dry material silo in the 3D printing process for construction.

In some aspects, the systems described herein relate to a mobile material transport system for 3D printing construction. Embodiments of the mobile material transport system include a portable container configured to store a granular material, such as a dry mix mortar. The system also includes a feed system coupled to the portable container that may continuously expel the granular material through a material output valve at a steady feed rate that may be controlled to adjust the feed rate up or down. Additionally, the system may include a power supply that powers the feed system, as well as any additional construction equipment, such as a material mixer or 3D printer.

In yet additional embodiments, the feed system may be further configured with an interface to expel the granular material to a material mixing unit. The controller may be further configured to communicate with the material mixing unit to coordinate the feed rate with an output rate of the material mixing unit as the printer material is consumed by the 3D printer in the build process. As the build rate changes due to the output speed of the 3D printer, the controller may increase the feed rate of dry mix material into the mixing unit. In yet additional embodiments, the system may include a second portable container configured to store a liquid, where a second feed system is coupled to the second portable container and configured to expel the liquid through a liquid output valve at a liquid feed rate. The controller may then control the liquid feed rate and communicate with the material mixing unit to coordinate the liquid feed rate with an output rate of the material mixing unit.

In additional embodiments of the system, a user interface may be configured to allow a user to operate the controller to increase or decrease the feed rate of the granular material. The interface may include a display that provides the user with the feed rate, and additional information concerning the 3D building process, such as print speed or status of material amounts remaining in the portable container.

In yet additional embodiments, a 3D printing construction system comprises a mobile material transport system, a material mixer and a 3D printer. The mobile material transport system of the 3D printing construction system includes a portable container and feed system configured to continuously expel the granular material through a material output valve at a steady feed rate, a controller for adjusting the feed rate, and a power supply configured to power the feed system. The material mixing unit is coupled to the material output valve of the mobile material unit and configured to receive granular material for mixing into construction build material. The 3D printer is coupled to the material mixing unit and configured to receive build material used to form structures by extruding successive layers of build material under computer control.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is an example portable silo for delivery at a construction site of the prior art;

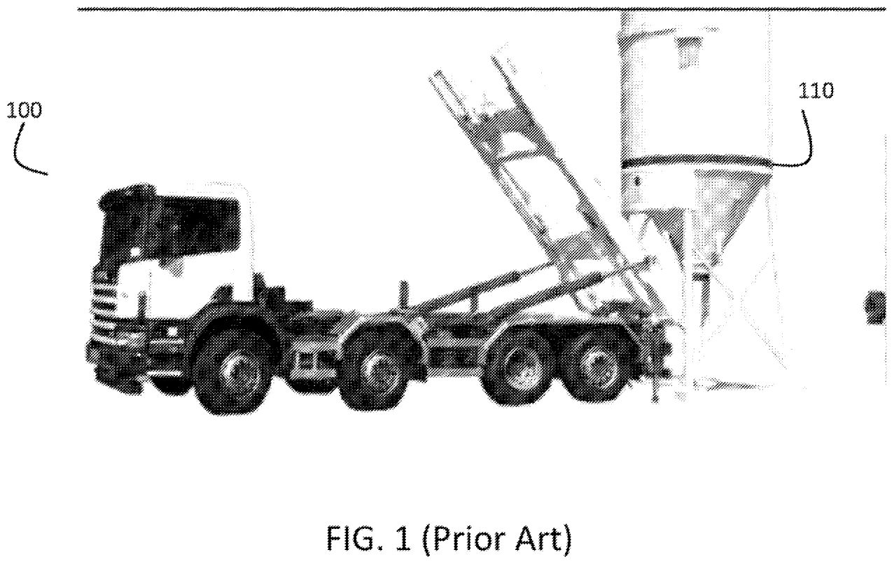

FIG. 2 is mobile material transport system consistent with some aspects of the present concepts; and

FIG. 3 is a 3-D printing construction system employing a mobile material transport system consistent with some aspects of the present concepts.

### DETAILED DESCRIPTION

A description of example embodiments follows.

At traditional large-scale construction sites, where significant amounts of cement or plaster may be used over the course of a month or longer, the powered or granular building material is typically stored in silos set up at the construction site. Construction 3D printers may use the same or similar dry mix mortar materials, so similar silos may be used. However, when using 3D printing in a construction process, as mentioned above, the building process typically involves a continuous of extruding construction material layer by layer to build structural components. As the layers of material are deposited, the construction material must be managed such that lower layers are given time to settle and harden enough to bear the load of later layers, while still remaining fresh and fluid enough to allow the successive layers to appropriately bond. Consumption of building material for 3D printing construction can occur over the course of several days, as structures are planned and built as continuous builds with managing the material with the rheology in mind.

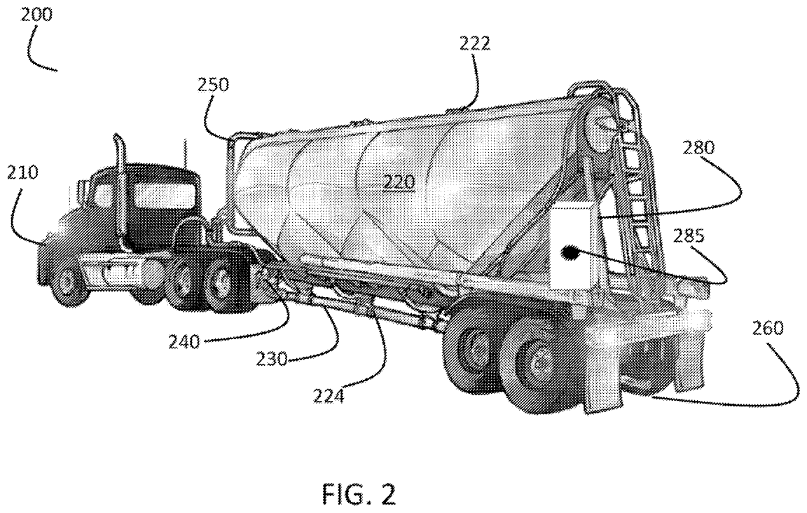

As shown in FIG. 2, embodiments of a mobile material transport system 200 consistent with some aspects of the present concepts eliminate the need for the traditional pre-construction site prep involving the delivery and installation of a dry material silo, as the mobile material transport system takes advantage of the 3D printing construction process where material is consumed quickly and can be advantageously managed.

The mobile material transport system 200 includes a container 220 that has a top hatch 222 that provides an opening in the container 220 for loading granular material. Due to the weight of the granular material, the material may collect at the bottom of the container 220. Coupled to the container is a feed system that includes a material transfer line 230 that provides an output valve 260 to expel the granular material. Along the bottom of container, valve openings 224 allow granular material to feed into a material transfer line 230. While the weight of the material may naturally push the material through the valve openings 224 into the material transfer line 230, in some embodiments as shown in FIG. 2, the feed system may include an airline 250 that uses air pressure to expel the granular material through the transfer line 230 and out of the output valve 260. A control valve 240 may be used to adjust the air pressure, and thus the feed rate of the granular material from the material transfer line. A controller (not shown) may be used to control the control valve 240. The controller may also be used to control the valve openings 224 and the output valve 260.

In some alternative embodiments not shown in FIG. 2, the system may include a second portable container configured to store a liquid, where a second feed system is coupled to the second portable container and configured to expel the liquid through a liquid output valve at a liquid feed rate.

In the mobile material transport system 200, a power supply 280 may be used to provide power to the controller and power the feed system. At a construction site, access to 3-phase electricity may be limited (especially for private housing construction). The power supply 280 can also be equipped with a connector 285 that may be used to provide power to construction equipment that may be part of an overall construction 3D printing system, such as a material mixer or construction 3D printer. The connector 285 may be a proprietary connector unit, or simply a 3-phase power outlet. The entire system may be placed on a wheeled platform, and coupled to a vehicle 210. The mobility of the system allows it to be advantageously positioned with case on a construction as needed to supply the granular material.

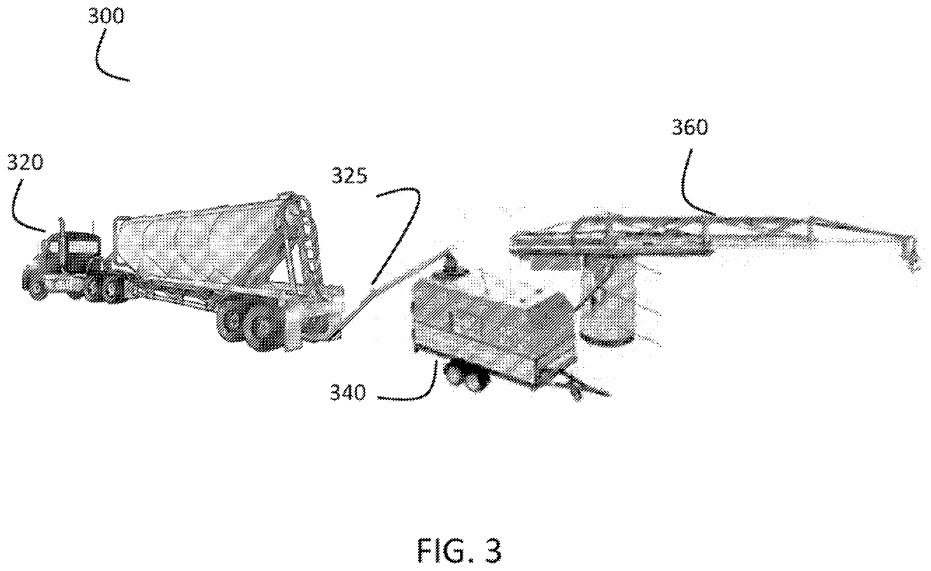

As shown in FIG. 3, a construction 3D printing system 300 may include the material transport system 320, a material mixer 340, and a 3D printer 360. The power provided by power supply can be sufficient to convey all of the material from the material transport system to the construction equipment, while also powering the consumption of that material by the material mixer and 3D printer. When the material in the material transport system runs out, a new material transport system arrives loaded with new material and a fully charged power supply.

The first material transport system can then return to the factory to refuel the material and charge the power supply.

In embodiments of the material transport system 320, the feed system may be further configured with an interface 325 to expel the granular material to the material mixing unit 340. A controller the material transport system 320 may be configured to communicate with the material mixing unit to coordinate the feed rate with an output rate of the material mixing unit 340 as the printer build material is consumed by the 3D printer 360 in the build process. The material mixing unit 340 may include sensors (not shown) to determine the amount of construction build material is available, and the rate of consumption of that build material.

As the build rate changes due to the output speed of the 3D printer, the material mixing unit 340 can provide that information to the material transport system 320 through a wired or a wireless communication, or simply send a request for additional feed of granular material. The controller in the material transport system 320 may then increase the feed rate of dry mix material into the mixing unit. In alternate embodiments where the material transport system 320 includes a second portable container configured to store a liquid, a controller may also control the liquid feed rate and communicate with the material mixing unit 340 to coordinate the liquid feed rate with an output rate of the material mixing unit 340.

One of skill in the art will appreciate that different types of construction 3D printers that may be used in connection with a construction 3D printing system 300 having the material transport system and the material mixer. As an example, the 3D printer may be a polar coordinate based deposition printer such as those described in U.S. Pat. No. 10,780,637 titled “3D Printer in Polar Coordinates.” Construction 3D printing systems as described here, provide connections between the material transport system and the 3D printer allowing for the smooth supply and processing of the granular material directly to 3D printing equipment, and a controller for controlling the flow and gating of the material supply through the system. Because the material is consumed by the 3D printer directly from the mixer and material transport system, there is better control over the quality and consistency of the material used. Without the need for on-site unloading of material into a silo, the is less concern of contaminants or environmental factors (humidity or rain) that might affect the material quality.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1-17. (canceled)

18. A construction system comprising:
a material mixing unit;
a mobile material transport system including:
a portable container configured to store a granular material;
a feed system coupled to the portable container and configured to continuously expel, to the material mixing unit, the granular material through a material output valve at a steady feed rate based on the material mixing unit;
a controller for adjusting the feed rate; and
a power supply configured to power the feed system and provide 3-phase power to construction equipment.

19. The system of claim 18 wherein granular material is a dry mix mortar for construction 3-D printing.
